(19) United States
(12) Patent Application Publication
(10) Pub. No.: US 2026/0172766 A1
(43) Pub. Date: Jun. 18, 2026

(54) EAR-WEARABLE ELECTRONIC DEVICE

(71) Applicant: Starkey Laboratories, Inc., Eden Prairie, MN (US)

(72) Inventor: Thomas Burns, St. Louis Park, MN (US)

(21) Appl. No.: 19/416,029

(22) Filed: Dec. 11, 2025

Related U.S. Application Data
(60) Provisional application No. 63/734,041, filed on Dec. 14, 2024.

(51) Int. Cl. H04R 25/00; H04R 25/02

(52) U.S. Cl. CPC H04R 25/609; H04R 25/02; H04R 25/604; H04R 25/652; H04R 25/658; H04R 25/456; H04R 25/48; H04R 2201/003; H04R 2225/023; H04R 2460/11

(57) ABSTRACT

Various embodiments of an ear-wearable electronic device are disclosed. The device includes a shell, a faceplate connected to a second end of the shell to form an enclosure, and an electromechanical package disposed at least partially within the enclosure. The package includes a flexible printed circuit board assembly (PCBA) disposed within the enclosure proximate to a first end of the shell and extending along an assembly axis, where the PCBA includes a concave inner surface and a convex outer surface; and a micro-mechanical systems (MEMS) receiver disposed on or at least partially in the concave inner surface of the PCBA. The device further includes an acoustic path disposed at least partially within the enclosure and extending between an inlet that is acoustically coupled to a receiver port of the MEMS receiver and an outlet that is disposed at the first end of the shell.

This application claims the benefit of U.S. Provisional Application No. 63/734,041, filed Dec. 14, 2025, the disclosure of which is incorporated by reference herein in its entirety.

### SUMMARY

In general, the present disclosure provides various embodiments of an ear-wearable electronic device that includes an electromechanical package disposed at least partially within an enclosure formed by a shell and a faceplate connected to the shell. The electromechanical package can include at least one micro-mechanical systems (MEMS) receiver disposed on or at least partially in a surface of a flexible printed circuit board assembly (PCBA) of the package that is disposed within the enclosure proximate to a first end of the shell configured to be disposed in an ear canal of an ear of a wearer. In one or more embodiments, the PCBA can take a non-planar shape having a concave inner surface and a convex outer surface. In such embodiments, the MEMS receiver can be disposed on either the concave inner surface or the convex outer surface. In one or more embodiments, the ear-wearable electronic device can be considered a deep-fit device that can position one or more electronic components of the electromechanical package such as the MEMS receiver deeper within the ear canal than is provided by currently available devices.

In one aspect, the present disclosure provides an ear-wearable electronic device that includes a shell including an outer surface that corresponds to an ear geometry of an ear of a wearer of the device, a first end configured to be disposed in an ear canal of the ear of the wearer, and a second end configured to be disposed proximate to a concha of the ear of the wearer. The device further includes a faceplate connected to the second end of the shell to form an enclosure with the shell that has an inner volume, and an electromechanical package disposed at least partially within the enclosure. The package includes a flexible printed circuit board assembly (PCBA) disposed within the enclosure proximate to the first end of the shell and extending along an assembly axis, where the PCBA includes a concave inner surface and a convex outer surface; and a micro-mechanical systems (MEMS) receiver disposed on or at least partially in the concave inner surface of the PCBA. The device further includes an acoustic path disposed at least partially within the enclosure and extending between an inlet that is acoustically coupled to a receiver port of the MEMS receiver and an outlet that is disposed at the first end of the shell.

In another aspect, the present disclosure provides an electromechanical package for an ear-wearable electronic device. The package includes a flexible printed circuit board assembly (PCBA) extending along an assembly axis, where the assembly includes a concave inner surface and a convex outer surface. The package further includes a micro-mechanical systems (MEMS) receiver disposed on or at least partially in the concave inner surface of the PCBA so that the MEMS receiver is disposed within an interior space defined by the concave inner surface of the PCBA, where the MEMS receiver includes a receiver port.

In another aspect, the present disclosure provides a method of forming an ear-wearable electronic device, including forming an electromechanical package. Forming the package includes forming a flexible printed circuit board assembly (PCBA) into a non-planar shape that includes a concave inner surface and a convex outer surface, and disposing a micro-mechanical system (MEMS) receiver on or at least partially in the concave inner surface of the PCBA. The method further includes disposing the electromechanical package at least partially within a shell, where the shell includes an outer surface that corresponds to an ear geometry of an ear of a wearer of the device, a first end configured to be disposed in an ear canal of the ear of the wearer, and a second end configured to be disposed proximate to a concha of the ear of the wearer; connecting a faceplate to the second end of the shell to form an enclosure with the shell that has an inner volume; and disposing an acoustic path at least partially within the enclosure, where the acoustic path extends between an inlet that is acoustically coupled to a receiver port of the receiver and an outlet that is disposed at the first end of the shell.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a,” “an,” and “the” are not intended to refer to only a singular entity but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a graph of a modeled shell of an ear-wearable electronic device.

FIG. 2A is a schematic perspective view of one embodiment of a prior art ear-wearable electronic device with a shell of the device made partially transparent for explanatory purposes.

FIG. 2B is a schematic perspective view of another embodiment of a prior art ear-wearable electronic device with a shell of the device made partially transparent for explanatory purposes.

FIG. 2C is a schematic perspective view of an embodiment of an ear-wearable electronic device with a shell of the device made partially transparent for explanatory purposes.

FIG. 3 is a graph of output versus frequency (Hz) for various types of transducers.

FIG. 4 is a schematic perspective view of another embodiment of an ear-wearable electronic device with a shell of the device made partially transparent for explanatory purposes.

FIG. 5 is a schematic perspective view of an electromechanical package of the ear-wearable electronic device of FIG. 4.

FIG. 6 is a schematic side view of the electromechanical package of FIG. 5.

FIG. 7 is a schematic side view of a MEMS receiver of the electromechanical package of FIG. 5 disposed on an inner surface of a PCBA of the package.

FIG. 8 is a schematic side view of the electromechanical package of FIG. 5.

FIG. 9 is a schematic side view of the electromechanical package of FIG. 5.

FIG. 10 is a schematic side view of the ear-wearable electronic device of FIG. 4 with the shell of the device made partially transparent for explanatory purposes.

FIG. 11 is a schematic front cross-section view of the electromechanical package of FIG. 5.

FIG. 12 is a schematic perspective of the ear-wearable electronic device of FIG. 4 disposed at least partially in an ear of a wearer.

FIG. 13 is a schematic cross-section view of the ear-wearable electronic device of FIG. 4 and an ear canal of the ear of the wearer of FIG. 12.

FIG. 14 is a block diagram of the ear-wearable electronic device of FIG. 4.

FIG. 15 is a schematic perspective view of the electromechanical package of FIG. 5 with a cover disposed on an outer convex surface of the PCBA and over a vent opening of a vent of the package.

FIG. 16 is a schematic cross-section view of the electromechanical package of FIG. 15.

FIG. 17 is a schematic perspective view of the cover of FIG. 15.

FIG. 18 is a schematic perspective view of another embodiment of an ear-wearable electronic device with a shell of the device made partially transparent for explanatory purposes.

FIG. 19 is a schematic side view of the ear-wearable electronic device of FIG. 18.

FIG. 20 is a schematic side view of the ear-wearable electronic device of FIG. 18 with an acoustic element of the device disposed at least partially within an opening of the device at a first end of the shell.

FIG. 21 is a schematic perspective view of another embodiment of an ear-wearable electronic device with a shell of the device made partially transparent for explanatory purposes.

FIG. 22 is a schematic perspective view of the ear-wearable electronic device of FIG. 21 with first and second covers disposed on an outer convex surface of a PCBA of an electromechanical package of the device and over vent openings of first and second vents of the package.

FIG. 23 is a schematic cross-section view of the electromechanical package of the device of FIG. 22.

FIG. 24 is a schematic perspective view of another embodiment of an ear-wearable electronic device with a shell of the device made partially transparent for explanatory purposes.

FIG. 25 is a flowchart of one embodiment of a method of forming the ear-wearable electronic device of FIG. 4.

### DETAILED DESCRIPTION

In general, the present disclosure provides various embodiments of an ear-wearable electronic device that includes an electromechanical package disposed at least partially within an enclosure formed by a shell and a faceplate connected to the shell. The electromechanical package can include at least one micro-mechanical systems (MEMS) receiver disposed on or at least partially in a surface of a flexible printed circuit board assembly (PCBA) of the package that is disposed within the enclosure proximate to a first end of the shell configured to be disposed in an ear canal of an ear of a wearer. In one or more embodiments, the PCBA can take a non-planar shape having a concave inner surface and a convex outer surface. In such embodiments, the MEMS receiver can be disposed on either the concave inner surface or the convex outer surface. In one or more embodiments, the ear-wearable electronic device can be considered a deep-fit device that can position one or more electronic components of the electromechanical package such as the MEMS receiver deeper within the ear canal than is provided by to currently available devices.

Two classifications of ear-wearable electronic devices include medical (i.e., prosthetic with an audiogram-based prescription) and consumer. Class II medical devices such as digital hearing aids are regulated by the Food and Drug Administration (FDA) for safety and effectiveness and are designed to amplify sound with significant acoustical gain while avoiding feedback, which manifests itself as an annoying whistle in an audio signal of the hearing aid. Consumer devices are designed to provide user delight with personalized audio and can include such features as premium sound quality, active noise cancellation, acoustic transparency, and spatial audio. Although a consumer device can provide acoustical gain when in transparency mode, this gain is limited and does not require signal processing for feedback control and, furthermore, cannot be marketed as a medical prosthetic as per FDA guidelines. Another FDA classification for non-prescription, Over-the-Counter (OTC) hearing aids is targeted for patients with mild to moderate hearing loss. These devices require some form of self-adjustment for volume and tone, and provide more acoustical gain than consumer devices but less than most Class II medical devices since Class II medical devices can also be prescribed for patients with mild to moderate hearing loss.

In this disclosure, anatomical references to an outer ear of a wearer include the pinna, concha, the triangular fossa located above the tragus, and the ear canal, These anatomical features are innervated with vagal fibers from the auricular branch of the vagal nerve. A typical ear canal has a first and second bend with a spiraled central axis resembling a sigmoid. An aperture (i.e., opening) of the ear canal is a planar interface between the concha and the ear canal, plus or minus one millimeter. The region between the aperture and the first bend contains cartilage, subcutaneous fat, and glands producing cerumen. Discomfort can occur if a hearing instrument stretches this cartilage improperly, or scratches or pinches the ear canal skin. The isthmus is the region between the first and second bends and contains subcutaneous fat and cerumen glands, though the thickness of this fatty tissue decreases in proximity to the second bend. This second bend only contains thin skin over the temporal bone and may be susceptible to physical discomfort if a hearing instrument is inserted therein. The region between the second bend and tympanic membrane also contains thin skin covering the temporal bone and is very susceptible to physical discomfort if anything is inserted there because of the proximity of the innervated vagal nerve to the region.

Managing these anatomical features can improve physical comfort, robustness to cerumen ingress, and electroacoustic performance of deep-fit devices. For example, if the cartilage is overstretched during insertion, the sensation of wearing a device can linger for hours after the device has been removed.

In general, currently available ear-wearable electronic devices can be categorized as open-fit, loose-fit, closed-fit, or deep-fit devices. Each of these categories typically use sealed, elastomeric earbuds, except for open-fit devices that can use non-sealing elastomeric spacers or other techniques to lodge a device within the concha. Medical devices typically use balanced armature (BA) receivers because of their transduction efficiency and low power consumption properties. In contrast to medical devices, consumer devices typically use moving-coil loudspeakers because they provide an effective low frequency bandwidth.

Open-fit consumer devices, such as the Bose Ultra Open Earbuds or Samsung Galaxy Buds, are designed to lodge between the base of the concha and the triangular fossa of the pinna without sealing the ear canal aperture. The Bose Ultra Open Earbuds clip onto the base of the concha and around the back of the pinna like jewelry and position the device very close to the aperture. The Galaxy Buds use a disk-shaped elastomeric spacer on the housing to provide a snug fit within the concha rather than an acoustical seal at the aperture. For both, the result is an open fit that allows ambient noise to propagate into the ear canal for more perceived situational awareness. To compensate for the acoustical openness, the internal loudspeaker is typically large and must generate additional low-frequency sound, thereby consuming more electrical power. These devices are considered comfortable to wear with good audio quality, but additional signal processing features such as active noise cancellation (ANC) may struggle to provide reliable and robust performance due to the open fit.

Loose-fit consumer devices, such as Apple AirPods, are designed to rest at the base of the concha so that an elastomeric earbud protrudes slightly into the aperture of the ear canal. Although these devices are considered comfortable to wear, the acoustical seal at this aperture is often compromised, leading to less low frequency sound, thereby requiring the user to adjust them for a tighter fit. Furthermore, larger dynamic transducers are needed to overcome the unreliable seal and maintain premium low frequency sound, which requires more electrical power and larger batteries. In general, fifteen-millimeter diameter moving coil transducers are common in this category of devices to provide adequate low frequency sound.

Closed-fit consumer devices, such as the Sony WF-C510, are designed to reside in the concha and be inserted beyond the aperture and up to the first bend of the ear canal so that the contact perimeter within the aperture is the primary boundary holding the device in place. Depending on the wearer's anatomy, these devices only create slight contact at the exterior perimeter of the concha and are considered slightly less comfortable compared to loose-fit devices. Further, balancing the mass of the device and the size of the tip without stretching and distorting the shape of the ear canal aperture and causing discomfort while maintaining an acoustical seal can be challenging. They provide, however, more consistent audio quality throughout daily use from person to person.

Deep-fit, i.e., deep-insertion medical devices such as Completely-in-Canal (CIC) or Invisible-in-Canal (IIC) hearing prosthetics, are popular because of their visual concealment to other people. Considering the FDA classification for OTC devices, there has been an effort to transition consumer devices into crossover OTC devices. As both consumer and medical devices converge, personalized audio features commonly found in consumer devices will be offered in medical devices. Since consumer devices are larger and positioned in the concha as compared to medical devices that are smaller and positioned within the first bend of the ear canal, the design principles used in consumer devices may not be optimal for deep-fit devices.

There is a need, therefore, for miniaturized, features of deep-fit devices to be utilized in consumer for an improved acoustical experience. These improvements can include but are not limited by the wearer delights of consumer devices associated with the phrase “personalized acoustics,” which can include such techniques as Active Noise Cancellation (ANC), occlusion management, acoustic transparency, in-situ audiometry, spatial audio, own-voice detection, insertion depth detection, adaptive audio mixing, and any other digital signal processing techniques that can adapt a feature to a wearer's physiology, environment, or preference.

The earliest electroacoustical transducers (e.g., receivers or speakers) used in telephony were based on moving armatures and evolved into balanced-armature “receivers” for hearing aid applications in the 1950's. Moving-coil (dynamic) transducers were introduced in the 1920's and evolved into very small devices capable of straddling the aperture of the ear canal. Mini dynamic earphones of the 1960's evolved into the larger high-fidelity drivers used in today's consumer devices, where the driver is typically positioned farther out into the concha. Although modern dynamic drivers can produce high outputs over a wide bandwidth when worn in the concha or just within the aperture of the ear, they're inefficient and consume significant electrical power. Balanced armature receivers, on the other hand, can fit deeper in the ear canal and are much more efficient than moving-coil devices, producing higher outputs with less electrical power, albeit over narrower bandwidths. For speech-in-babble applications where narrow bandwidths are sufficient and low electrical power consumption is critical, and for prosthetic applications where invisibility is highly desired, balanced armature receivers have been used exclusively.

Recently there have been technological developments in foundry-based, MEMS receivers. These devices can be solder-reflowed onto a (semi)rigid circuit board, thereby minimizing manual hand-solder operations. The circuit board can be shaped to fit in the concha, as is currently offered in consumer devices. One or more embodiments of the present disclosure can provide an ear-wearable electronic device that includes one or more MEMS receivers that are solder reflowed onto flexible circuits, along with other foundry-based components.

One or more embodiments of ear-wearable electronic devices described herein can provide various advantages over currently available devices. For example, a deep-fit ear-wearable electronic device that includes one or more receivers can be disposed on a PCBA that includes one or more flexible portions and that can be disposed within a shell of the device proximate to a first end of the shell that is disposed within an ear canal of a wearer.

The position of a deep-fit ear-wearable electronic device can be defined as a device that is disposed anywhere within the aperture of the inner canal. In this disclosure, one or more embodiments of devices can include a shell that is configured to straddle the first bend of the ear canal with one or more electronic components or circuitry disposed within the shell and located between the first and second bend of the inner ear.

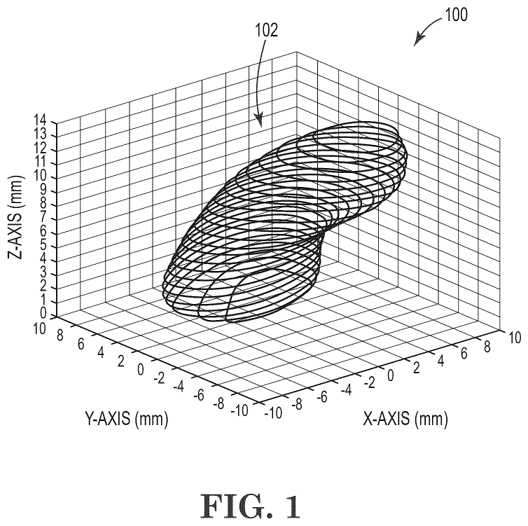

The shape of the inner ear has been documented by Stinson et al. (Specification of the geometry of the human ear canal for the prediction of sound-pressure level distribution. J. Acoust. Soc. Am. 85(6 ), June 1989). In general, the geometry of a shell 102 of a device designed to fit snugly and straddle the first bend of the human inner ear is illustrated in a modeled graph 100 in FIG. 1. Cross sections are generally ovular with a spiraled central axis (not shown) resembling a sigmoid. In subsequent figures, the illustration of FIG. 1 is rendered as a 3D, hollow, translucent surface whose inner volume can vary, depending on a person's anatomy, between approximately 700 mm\hat{ }3 and 2 cm\hat{ }3 while maintaining the same general shape.

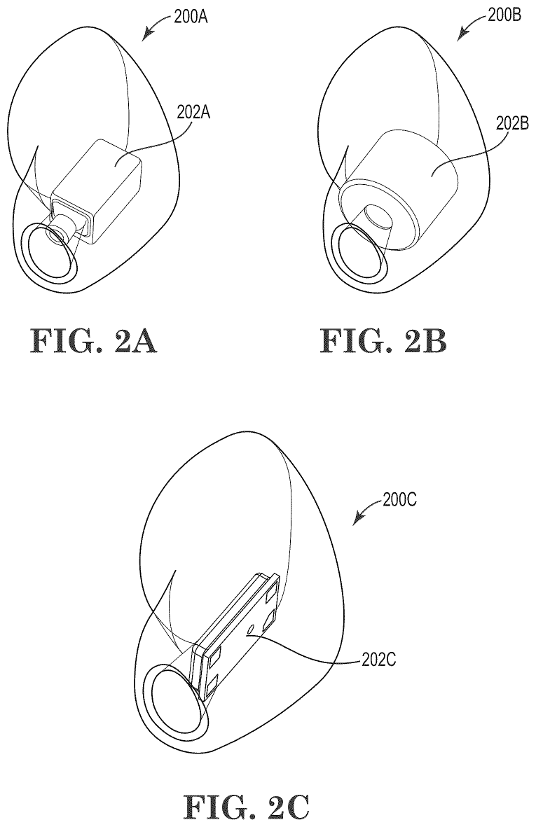

Consider a prior art balanced armature (BA) receiver 202A used in Class II hearing device 200A as shown in FIG. 2A, rendered to scale with a prior art device 200B having a moving coil (MC) receiver 202B in FIG. 2B, and a MEMS receiver 202C in a device 200C in FIG. 2C. Although MC receivers have not been considered in Class II hearing devices due to intrinsically poor efficiency, a 4 mm diameter version has been included here for reference. Consumer devices typically use MC receivers (often referred to as dynamic drivers) having a diameter of 8\hat{ }mm to 15\hat{ }mm that are positioned farther out on the concha.

In both the BA and MC receivers 202A, 202B, an electromechanical coil, magnet, and diaphragm is engineered to vibrate and create acoustic waves. The electromagnetic circuit in the BA receiver 202A is more efficient than the MC receiver 202B, and in hearing aid applications, is typically driven with a Class-D amplifier. In the MEMS receiver 202C, a distributed array of piezoelectric actuators embedded on a silicon substrate (hereinafter referred to as a MEMS membrane) and fabricated upon a (semi)rigid substrate are engineered to create acoustic waves and can be driven with a Class-H amplifier. The (semi)rigid substrate can be made of, but not limited to, flame retardant glass-reinforced epoxy resin (FR4) or Bismaleimide-Triazine (BT) resin.

The internal diaphragm of the BA receiver 202A (FIG. 2A) separates its housing into two air volumes: the front air volume, which is coupled to the spout, and the rear air volume (typically about thrice the volume of the front), which is sealed. Some applications incorporate a small hole in the housing to couple the rear air volume to the ambient field for enhanced low-frequency output. The same is true for the MC receiver 202B (FIG. 2B), where the rear volume can be vented to either a larger air volume or to the ambient field to enhance low-frequency output. In both the BA and MC receivers 202A, 202B, an isobaric pierce hole is commonly integrated on the edge of the diaphragm. Similarly, the MEMS membrane of the MEMS receiver 202C (FIG. 2C) separates the internal volume into a front and rear; however, the distributed actuators in the quiescent position are not acoustically sealed. Instead, their edges are engineered to leave a small air gap, which also functions as an isobaric vent. Thus, the front and rear air volumes are coupled through a meander of air gaps in the MEMS membrane, depending on the actuator layout. In general, acoustic waves are engineered to propagate through the front air volume and out an orifice on the top lid. In this disclosure, the (rectangular) orifice or receiver port is disposed on the side of the top lid. The rear air volume directly below the PM membrane is coupled to a back vent engineered into the receiver's (semi)rigid substrate. Acoustic waves radiating from the back vent and out of the MEMS receiver 202C are referred to herein as a back wave. In MEMS receiver applications, the back wave can be controlled for low frequency response, and for high-gain devices, the back wave can be prevented from entering a lateral microphone (often mounted on the device's faceplate) to reduce acoustical feedback, which can manifest as an annoying whistle in the audio signal of the device.

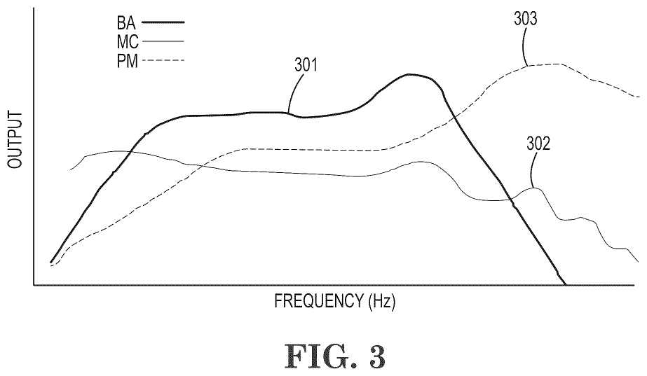

FIG. 3 is a graph of generalized frequency response for the receivers of FIG. 1A-C, where the receivers are directly sealed to a simulated rear ear coupler. A BA receiver response shown as curve 301 is dominated by a broad peak in mid frequencies. This peak is due to the superposition of a mechanical armature resonance in series with parallel Helmholtz resonances between the inertance of air in the spout and the compliance of air in both the front air volume and the coupler air volume. The response rolls off approximately at 18 dB per octave in high frequencies and 12 dB per octave at very low frequencies. Compared to the BA receiver, the MC receiver as shown as curve 302 is intrinsically less efficient, thereby producing less output with a wider bandwidth and rolling off 6 dB per octave at both the high and low frequencies with diaphragm breakup modes contributing to the irregular response in the high frequencies. Compared to the BA receiver, the MEMS receiver as shown as curve 303 has less output at low frequencies but excellent efficiency and Signal-to-Noise Ratio (SNR) at high frequencies, which, for most of the aged population, is where sensorineural hearing loss is pronounced. The improved SNR allows higher outputs at high frequencies with less perceived hiss from circuit noise. Furthermore, for moderate to severe hearing prescriptions, the requirement for low frequency gain is modest, which means excessive low frequency output is not needed. For these reasons, a MEMS receiver can be of benefit for ear-wearable electronic devices. It should be noted that the low frequency response of the MEMS receiver in FIG. 3 can be enhanced with proper engineering of the back wave.

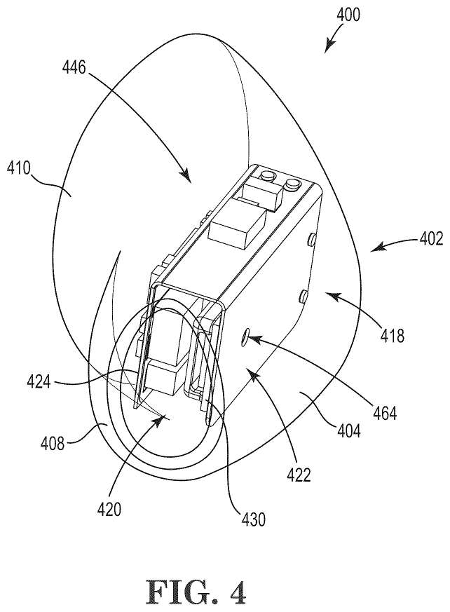

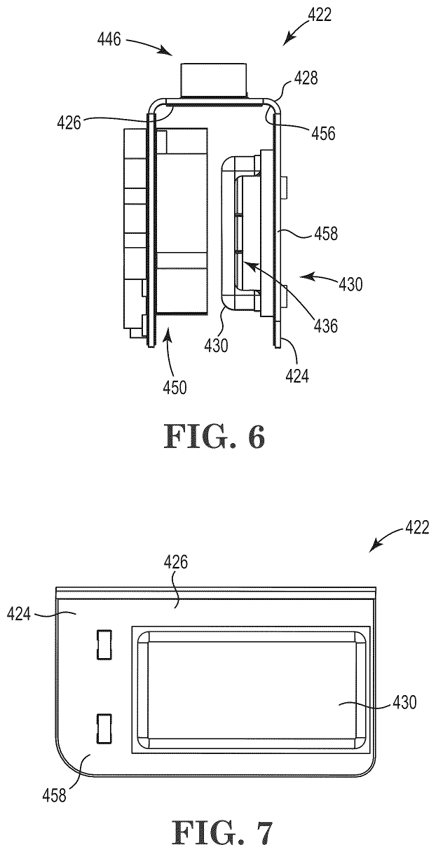

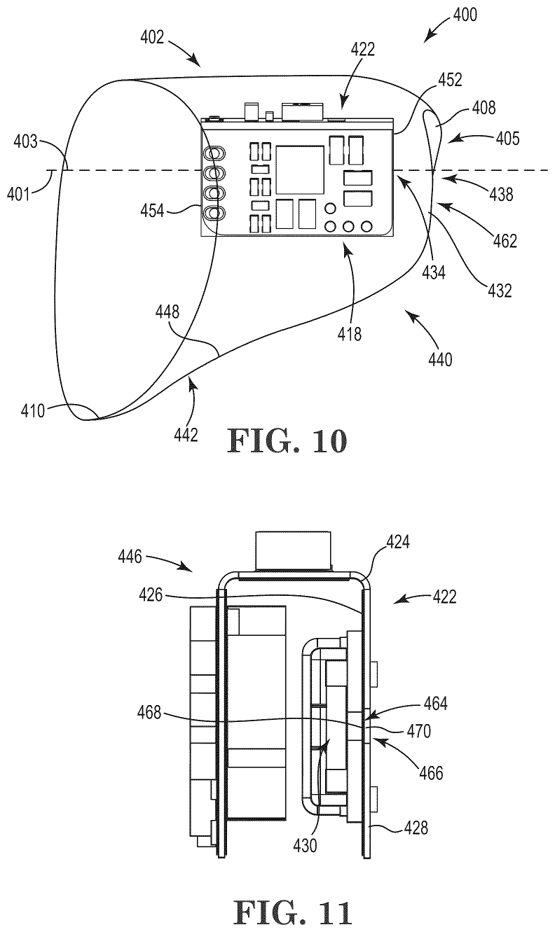

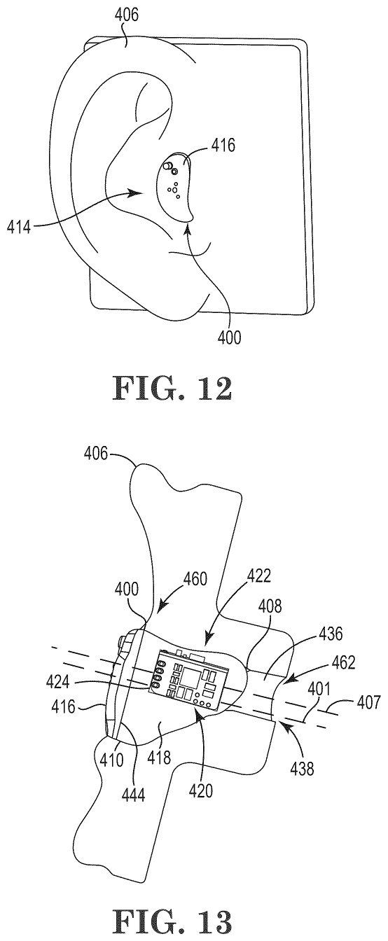

FIG. 4 is the schematic perspective view of another embodiment of an ear-wearable electronic device 400 with a shell 402 of the device made transparent for clarity. The device 400 includes the shell 402 that has an outer surface 404 that corresponds to an ear geometry of an ear 406 (FIGS. 12-13) of a wearer of the device, a first end 408 configured to be disposed in an ear canal 460 of the ear of the wearer, and a second end 410 configured to be disposed proximate to a concha 414 of the ear of the wearer. The device 400 further includes a faceplate 416 (FIGS. 12-13) connected to the second end 410 of the shell 402 to form an enclosure 418 with the shell having an inner volume 420, and an electromechanical package 422 disposed at least partially within the enclosure. The package 422 includes a flexible printed circuit board assembly (PCBA) 424 disposed within the enclosure 418 proximate to the first end 408 of the shell 402 and extending along an assembly axis 401. The PCBA 424 includes a concave inner surface 426 (FIG. 6) and a convex outer surface 428. The device 400 further includes a micro-mechanical systems (MEMS) receiver 430 disposed on or at least partially in the concave inner surface 426 of the PCBA 424, and an acoustic path 432 (FIG. 10) disposed at least partially within the enclosure 418 and extending between an inlet 434 that is acoustically coupled to a receiver port 436 (FIG. 6) of the MEMS receiver and an outlet 438 that is disposed at the first end 408 of the shell 402.

The ear-wearable electronic device 400 can include any suitable device. For example, the ear-wearable electronic device 400 can be a hearing assistance device. Any suitable hearing assistance device can be utilized, e.g., behind-the-ear (BTE), in-the-ear (ITE), in-the-canal (ITC), receiver-in-canal (RIC), completely-in-the-canal (CIC), or invisible-in-the-canal (IIC)-type hearing assistance devices. It is understood that BTE type hearing assistance devices can include devices that reside substantially behind the ear or over the ear. Such devices can include hearing aids with receivers associated with the electronics portion of the device or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and deep insertion devices having a transducer, such as a receiver or microphone, whether custom fitted, standard, open fitted, or occlusive fitted. The present subject matter can additionally be used in consumer electronic wearable audio devices having various functionalities. It is understood that other devices not expressly stated herein can also be used with the present subject matter. Further, the device 400 can be included in an ear-wearable electronic device system that includes two or more devices. For example, the device 400 can be a first device disposed at least partially within an ear of a wearer, and a second ear-wearable electronic device can be disposed at least partially within a second ear of the wearer.

The outer surface 404 of the shell 402 of the device 400 can take any suitable shape and have any suitable design such that at least a portion of the enclosure fits at least partially within the wearer's ear 406. The device 400 can include any suitable components such as one or more of a port, spout, earbud, antenna, cover, or any other components suitable for assisting in the performance or function of the device. The device 400 can include any number of such components connected to or integral with the enclosure 418 (e.g., two antennas, three spouts, etc.). These components can be disposed in any suitable location or arrangement for assisting in the performance or function of the device 400.

The shell 402 can take any suitable shape and have any suitable dimensions so that at least a portion of the enclosure fits within the ear of the wearer. The shell 402 can define the inner volume 420. Further, the shell 402 can include any suitable material, e.g., at least one of an inorganic material (e.g., metallic or ceramic material) or organic material (e.g., a polymeric material such as a thermoplastic or thermoset material). The shell 402 can be manufactured using any suitable technique, e.g., molding, injection molding, 3D printing, etc.

As mentioned herein, the shell 402 can also have any suitable dimensions. As shown schematically in FIG. 10, the shell 402 includes a first portion (i.e., posterior portion) 440 and a second portion (i.e., anterior portion) 442. The first portion 440 is adjacent the first end 408 of the shell and the second portion 442 is adjacent the second end 410 of the shell. As is further described herein, in one or more embodiments, at least the electromechanical package 422 can be disposed in at least one of the first portion 440 or the second portion 442 of the shell.

The first and second portions 440, 442 can each have any suitable cross-sectional area in a plane orthogonal to a longitudinal axis 403 of the device 400 (FIG. 10). The longitudinal axis 403 is defined as an axis that is substantially perpendicular to an inner surface 444 of the faceplate 416 at a center point of the inner surface, where the center point is a geometrical center of the inner surface of the faceplate. In one or more embodiments, the second portion 442 has a maximum cross-sectional area that is greater than a maximum cross-sectional area of the first portion 440. The cross-sectional area of the first portion 440 can be constant along the longitudinal axis 403 or vary along the longitudinal axis. Further, the cross-sectional area of the second portion 442 can be constant along the longitudinal axis 403 or vary along the longitudinal axis.

Connected to the shell 402 is the faceplate 416 (FIGS. 12-13). The faceplate 416 can take any suitable shape and have any suitable dimensions. Further, the faceplate 416 can include any suitable materials, e.g., at least one of an inorganic (e.g., metallic, ceramic) or organic material. In one or more embodiments, the faceplate 416 includes a nylon-based polyamide thermoplastic material. The faceplate 416 can be manufactured using any suitable technique, e.g., molding, injection molding, 3D printing, etc. The faceplate 416 can be connected to the second end 410 of the shell 402 using any suitable technique, e.g., adhering, mechanically fastening, friction fitting, bonding, molding, etc. Once connected, the faceplate 416 and the shell 402 form the enclosure 418 that includes or defines the inner volume 420.

Disposed at least partially within such enclosure 418 is the electromechanical package 422. The package 422 can be disposed entirely within the enclosure 418. In one or more embodiments, one or more portions of the package 422 can be disposed on an outer surface of the enclosure 418 or spaced apart from the enclosure. The package 422 can be disposed at least partially within any suitable or portions of the enclosure 418. In one or more embodiments, the electromechanical package 422 can be disposed proximate to the first end 408 of the shell 402. Further, the package 422 can extend along the assembly axis 401.

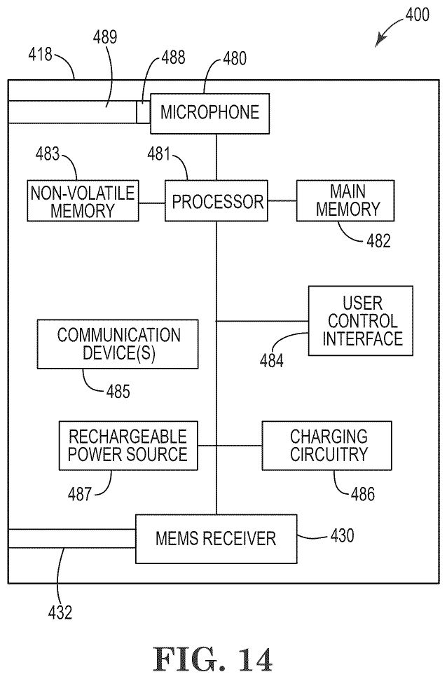

In general, the device 400 can include any suitable electronic circuitry and components disposed on or within the device, e.g., one or more of the electronic circuitry and components described herein (e.g., as described regarding FIG. 14). For example, the device 400 includes the electromechanical package 422 that can include any suitable electronic components or circuitry 446. Such components 446 can be disposed on or at least partially in the PCBA 424. In one or more embodiments, one or more components 446 of the package 422 can be spaced apart from the PCBA 424 and electronically connected to one or more additional components disposed on or partially in the PCBA using any suitable technique.

The PCBA 424 can include any suitable substrate, conductive, and insulative layers. It is understood that the flexible PCBA 424 is a laminated, flexible sandwich structure that can include conductive layers, insulating layers, and vias allowing for interconnections between layers. The circuit substrates considered in this disclosure encompass any rigid substrate including FR4, bismaleimide-triazine (BT) epoxy, ceramic, beryllium oxide, or composite epoxy materials (CEM). In addition, flexible substrates considered in this disclosure include polyimide, PEEK, PET, transparent conductive polyester or 1:1 film. Any combination of ‘flex-rigid’ such as FR4 and polyimide also is intended in this disclosure.

In one or more embodiments, the PCBA 424 can include one or more rigid portions. In one or more embodiments, the PCBA 424 can include one or more flexible portions. In one or more embodiments, the PCBA 424 can include one or more rigid portions and one or more flexible portions. As shown in FIG. 6, the PCBA 424 can include one or more flexible portions 456 that each can include one or more fold lines that facilitate forming the PCBA into any suitable shape. In such embodiments, the PCBA 424 can be manufactured as a substantially planar substrate and then formed into a non-planar shape along one or more fold lines disposed in one or more flexible portions 456. The circuitry 446 can be disposed on or at least partially in the PCBA 424 either prior to or after the PCBA has been formed into a desired shape. The PCBA 424 can also include one or more rigid portions 458 as shown in FIG. 6. In one or more embodiments, the MEMS receiver 430 can be disposed on or at least partially in the rigid portion 458 using any suitable technique.

The PCBA 424 includes concave inner surface 426 and the convex outer surface 428. As used herein, the phrase “concave inner surface” refers to an inner surface of the PCBA 424 where at least one line segment can be drawn between two points on the surface that lies outside the shape itself. Further, as used herein, the phrase “convex outer surface” refers to an outer surface of the PCBA 424 that for any two points on the surface a line segment connecting them lies entirely within or on the surface. In one or more embodiments, the concave inner surface 426 can include at least one of a curved portion or a flat portion. Further, the convex outer surface 428 can include at least one of a curved portion or a flat portion.

In general, the PCBA 424 can take any suitable cross-sectional shape in a plane orthogonal to the assembly axis 401. For example, in one or more embodiments, the PCBA 424 can take a rectangular shape in a cross-sectional plane orthogonal to the assembly axis 401 as shown in FIG. 6. In one or more embodiments, the PCBA 424 can take an elliptical shape in the cross-sectional plane. In one or more embodiments, the PCBA 424 can take a U-shape in the cross-sectional plane. In one or more embodiments, the assembly axis 401 can be substantially orthogonal to a plane 405 defined by the outlet 438 of the acoustic path 432 (FIG. 10). Further, the assembly axis 401 can be substantially parallel to an ear canal axis 407 of the ear 406 of the wearer as shown in FIG. 13.

Further, the cross-sectional shape of the PCBA 424 can be an enclosed shape or an open shape as shown in FIG. 6. For example, as shown in FIG. 6, the PCBA 424 takes an open rectilinear cross-sectional shape. The cross-sectional shape of the PCBA 424 can be enclosed by adding a fourth side to form an enclosed rectangle in cross-section. Further, the PCBA 424 can take any suitable shape in a plane substantially parallel to the assembly axis 401, i.e., in the plane of FIG. 10. For example, the PCBA 424 can take a cylindrical, conical, or rectilinear shape in the plane parallel to the assembly axis 401.

The PCBA 424 can extend along the assembly axis 401 between a first end 452 and a second end 454 as shown in FIG. 10. In one or more embodiments, at least one of the first end 452 or second end 454 can be sealed or closed using any suitable technique, e.g., by disposing an insulating material over at least one end. In one or more embodiments, an addition portion of the PCBA 424 can be folded over or attached to one or both ends 452, 454 using any suitable technique to seal the end.

The PCBA 424 can be disposed within any suitable portion or portions of the enclosure 418. As shown in FIG. 10, and 13, the PCBA 424 is disposed within the enclosure proximate to the first end 408 of the shell 402. The PCBA 424 can be mounted within the enclosure 418 using any suitable technique. In one or more embodiments, the PCBA 424 is connected to the inner surface 448 of the shell 402.

Disposed on or at least partially in the concave inner surface 426 of the PCBA 424 is the MEMS receiver 430. In one or more embodiments, the MEMS receiver 430 can be disposed on the outer convex surface 428 of the PCBA 424. In one or more embodiments, the inner surface 426 of the PCBA 424 can define an interior space 450 as shown in FIG. 6. The MEMS receiver 430 can be disposed within or at least partially within this interior space 450.

The device 400 can include any suitable number of MEMS receivers 430 disposed on the PCBA 424 or elsewhere within the enclosure 418. The MEMS receivers 430 can include any suitable MEMS receiver or speaker. Although the package 422 includes the MEMS receiver 430, in one or more embodiments, the package 422 can include any other suitable type of receiver.

Further, the MEMS receiver 430 can be disposed on the PCBA 424 using any suitable technique, e.g., surface mounting. The MEMS receiver 430 can be disposed on or at least partially within any suitable portion of the PCBA 424. In one or more embodiments, one or more MEMS receivers 430 can be disposed on at least one of the inner surface 444 of the faceplate 416 or on the inner surface 448 (FIG. 10) of the shell 402, and electrically connected to one or more devices disposed within the enclosure 418 (e.g., on or at least partially within the PCBA 424) using any suitable technique. The MEMS receiver 430 can be disposed in any suitable location within the enclosure 418. As shown, the MEMS receiver 430 is disposed proximate to the first end 408 of the shell 402.

Acoustic waves from the MEMS receiver 430 can be directed to the ear canal 460 or can propagate into the ear canal of the wearer using any suitable technique. For example, the acoustic path 432 can be disposed at least partially within the enclosure 418 and extend between the inlet 434 that is acoustically coupled to the receiver port 436 of the MEMS receiver 430 and the outlet 438 that is disposed at the first end 408 of the shell 402 (FIGS. 10 and 13). The acoustic path 432 can include any suitable material and take any suitable shape. Further, the acoustic path 432 can have any suitable dimensions. In one or more embodiments, the acoustic path 432 can be a separate tube or conduit that is disposed at least partially within the shell 402. In one or more embodiments, the acoustic path 432 can be a channel that is disposed or formed in the shell 402.

The inlet 434 of the acoustic path 432 can be acoustically coupled to the receiver port 436 of the MEMS receiver 430 using any suitable technique. Further, the outlet 438 of the acoustic path 432 can extend through an opening 462 defined by the first end 408 of the shell 402 or be acoustically coupled to the opening without extending through the first end of the shell.

In one or more embodiments, one or more acoustic seals (not shown) can be utilized between the receiver port 436 of the MEMS receiver 430 and the ear canal 460 so that the receiver is acoustically coupled to the ear canal. In one or more embodiments, an acoustic seal can be disposed at least partially within the interior space 450 of the PCBA 424 that can acoustically couple the MEMS receiver 430 and one or more additional components or circuitry of the electromechanical package 422 to the ear canal 460. Any suitable material can be utilized to form such acoustic seals.

The MEMS receiver 430 can include one or more vents 464 (FIGS. 4 and 11) that are configured to be coupled to a rear air volume directly below a membrane of the receiver. Acoustic waves radiating from the vent 464 and out of the MEMS receiver 430 can be referred to as back waves. In one or more embodiments, the back wave can be controlled for low frequency response, and for high-gain devices, the back wave can be prevented from entering a microphone of the device 400 (e.g., mounted on the hearing aid's faceplate 416) to reduce acoustical feedback, which can produce a high-pitched whistling sound in one or more acoustic signals directed to the wearer.

As shown in FIG. 11, the vent 464 of the MEMS receiver 430 can be in fluid communication with a vent path 466 that extends through the PCBA 424 between a first opening 468 defined by the inner surface 426 of the PCBA and a second opening 470 defined by the outer surface 428 of the PCBA. The vent 464 of the MEMS receiver 430 can be in fluid communication with the inner volume 420 of the enclosure 418 via the vent path 466.

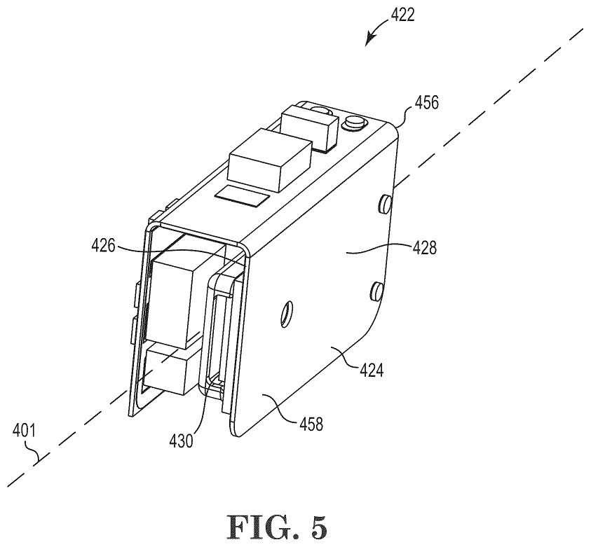

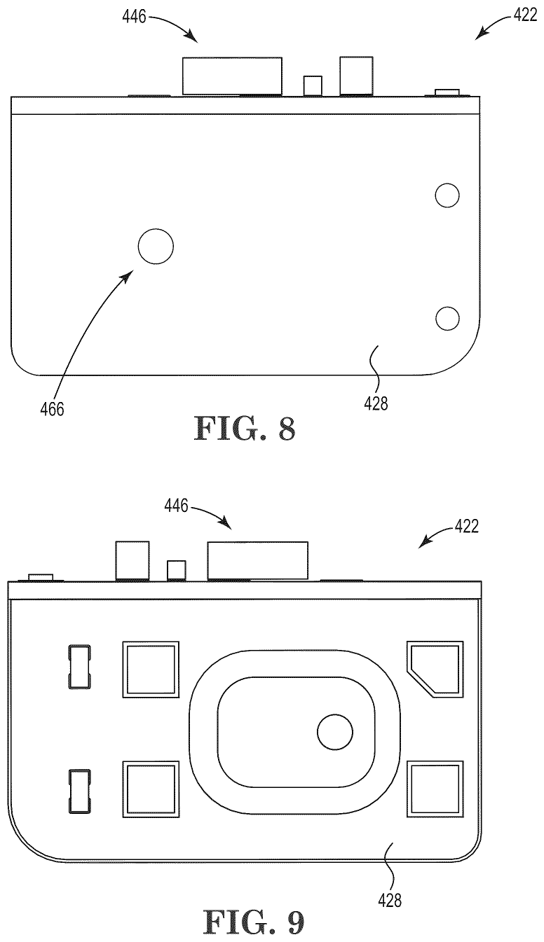

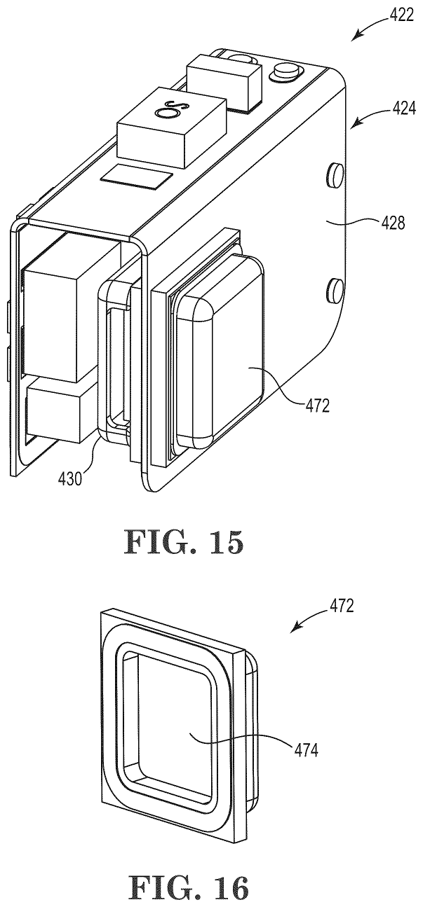

In one or more embodiments, one or more covers can be disposed on the outer surface of the PCBA and over the second opening of the vent path. For example, FIG. 15 is a schematic perspective view of the electromechanical package 422 of FIGS. 4-13 with a cover 472 disposed on or at least partially in the outer convex surface 428 of the PCBA 424. The cover 472 includes a cavity 474 disposed in the cover as shown in FIG. 16. The outer surface 428 of the PCBA 424 and the cavity 474 of the cover 472 define a cover volume 476 (FIG. 7). The cover 472 can be disposed over the second opening 470 of the vent path 466 that extends between the first opening 468 and the second opening. A vent 464 of the MEMS receiver 430 is in fluid communication with the vent path 466. The vent 464 is in fluid communication via the vent path 466 with the cover volume 476.

The cover 472 can take any suitable shape and have any suitable dimensions. Further, the cover 472 can include any suitable material. In one or more embodiments, the cover 472 can be a pick and place printed circuit board (PCB) rim with a stamped metal cover bonded to it. In one or more embodiments, the cover 472 can be a PCB substrate that is etched to form the cavity 474. The cover 472 can be connected to the outer surface 428 using any suitable technique. In one or more embodiments, a copper trace can be disposed on each of the cover 472 and the outer surface 428 of the PCBA 424 that can be reflowed to connect the cover to the outer surface, thereby creating a perimeter seal between the cover and the outer surface. Although not shown, the cover 472 can include additional venting features or structures to further assist in venting back waves from the MEMS receiver 430. For example, one or more acoustical conduits can be disposed in the cover to control overall frequency response. Such acoustical conduits can include, e.g., one or more holes, capillary tubes, slits, or any other openings disposed in or defined by the cover 472.

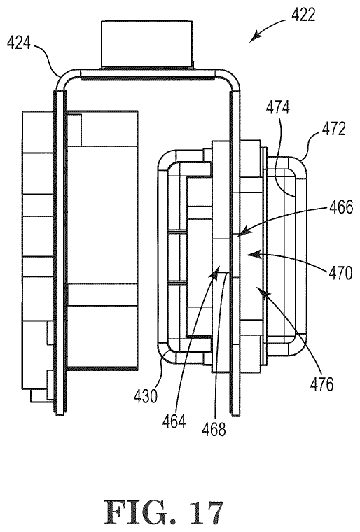

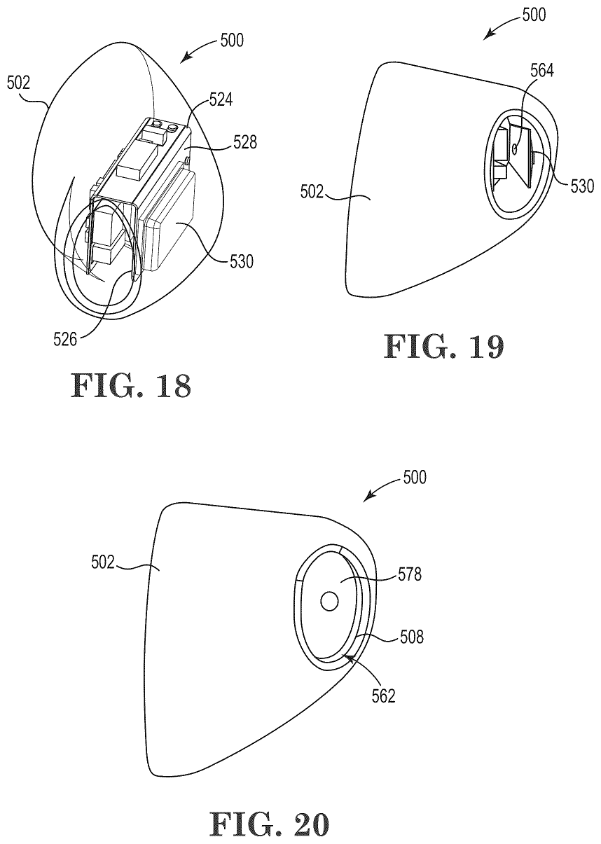

As mentioned herein, the MEMS receiver 430 can be disposed on or at least partially in any suitable portion of the PCBA 424. For example, in one or more embodiments, one or more MEMS receivers can be disposed on a convex outer surface of a PCBA. For example, FIG. 18-19 are schematic perspectives views of another embodiment of an ear-wearable electronic device 500. All design considerations and possibilities described herein regarding ear-wearable electronic device 400 of FIGS. 4-17 apply equally to ear-wearable electronic device 500 of FIGS. 18-19 unless stated otherwise. One difference between device 500 and device 400 is that a MEMS receiver 530 of the device 500 is disposed on a convex outer surface 528 of PCBA 524 instead of or in addition to a MEMS receiver disposed on a concave inner surface 526 of the PCBA. As illustrated in FIG. 19, which is a schematic perspective of the device 500 with the PCBA 524 removed for clarity, a vent 564 of the MEMS receiver 530 can be acoustically coupled to an ear canal of the wearer (e.g., ear canal 460 of ear 406 of FIG. 13). Although not shown, the vent 564 of the receiver 530 can be acoustically coupled to a vent path disposed through the PCBA 524 (such as shown in FIG. 16 for vent path 466). Further, a cover (e.g., cover 472 of FIG. 17) can be disposed on or at least partially in the concave inner surface 526 of the PCBA 524 and over an opening of the vent path so that the vent 564 is in fluid communication via the vent path with a cover volume defined between the inner surface 526 of the PCBA 524 and a cavity disposed in the cover.

Further, in one or more embodiments, an acoustical element 578 as shown in FIG. 20 can be utilized to acoustically couple the MEMS receiver vent 564 to the ear canal. The element 578 can be disposed adjacent an opening 562 defined by a first end 508 of a shell 502 of the device 500 and configured to provide a desired frequency response using any suitable technique. Further, the acoustical element 578 can be configured to provide debris ingress protection using any suitable technique.

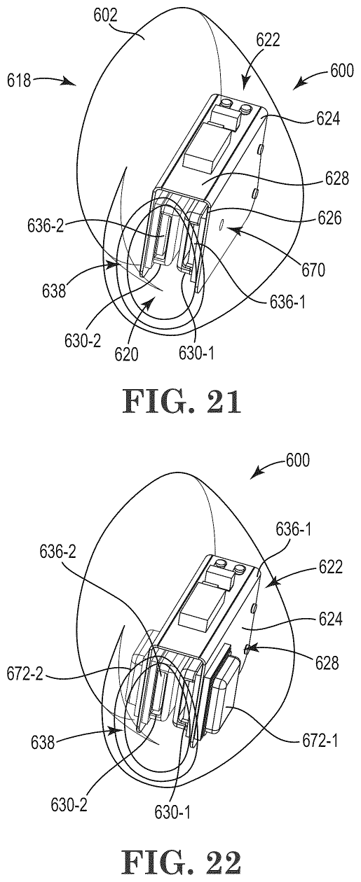

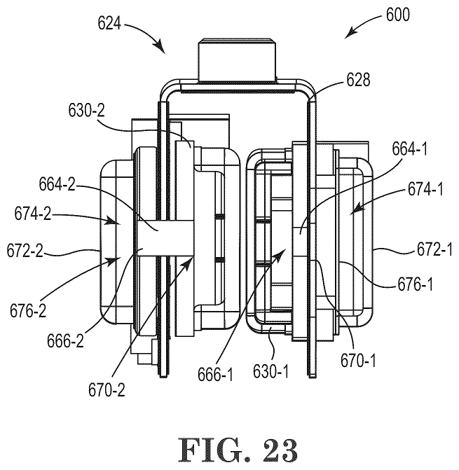

As mentioned herein, the various embodiments of ear-wearable electronic devices described herein can include any suitable number of MEMS receivers. For example, FIGS. 21-23 are various views of another embodiment of an ear-wearable electronic device 600. All design considerations and possibilities described herein regarding ear-wearable electronic device 400 of FIGS. 4-17 apply equally to ear-wearable electronic device 600 of FIGS. 21-23. One difference between device 600 and device 400 is that device 600 includes a first MEMS receiver 630-1 and a second MEMS receiver 630-2 (collectively referred to herein as MEMS receivers 630). Each of the first and second MEMS receivers 630-1 and 630-2 are disposed on a concave inner surface 626 of a PCBA 624 of electromechanical package 622. Although depicted as including two MEMS receivers 630-1 and 630-2, the device 600 can include any suitable number of MEMS receivers. For example, in one or more embodiments, a third MEMS receiver can be disposed on an outer convex surface 628 of the PCBA 624 or on the inner concave surface 626 of the PCBA. Each of the MEMS receivers 630 can be disposed on or at least partially in the inner surface 626 of the PCBA 624 using any suitable technique. Further, each of the MEMS receivers 630 can be disposed on any suitable portion or portions of the inner surface 626 of the PCBA 624. A vent 664-1 (FIG. 23) of the first MEMS receiver 630-1 and a vent 664-2 of the second MEMS receiver 630-2 (collectively referred to herein as vents 664) can direct acoustic energy into an inner volume 620 of the enclosure 618 that is formed by the shell 602 and a faceplate (not shown) connected to the shell (e.g., faceplate 416 of device 400 of FIG. 13). The vents 664 of the MEMS receivers 630 can share indirect mutual acoustical coupling through the inner volume 620 of the enclosure 618.

The first MEMS receiver 630-1 can include a receiver port 636-1 (FIG. 21) disposed in any suitable orientation relative to an outlet 638 of a shell 602 of the device 600. Further, a receiver port 636-2 of the second MEMS receiver 630-2 can also be disposed in any suitable relationship relative to the outlet 638 of the shell 602. As shown in FIGS. 21-22, the receiver ports 636-1 and 636-2 are oriented such that acoustic energy provided by the MEMS receivers 630 can be directed to or propagate through the outlet 638 of the shell 602.

In one or more embodiments, the package 622 can also include a first cover 672-1 disposed on the outer surface 628 of the PCBA 624 and over a second opening 670 of a first vent path 666-1, where the vent 664-1 of the first MEMS receiver 630-1 is in fluid communication via the vent path with a cover volume 676-1 defined between the outer surface the PCBA and a cavity 674-1 disposed in the first cover. Similarly, in one or more embodiments, a second cover 672-2 can be disposed on the outer surface 628 of the PCBA 624 and over a second opening 670-2 of the second vent path 666-2, where the vent is in fluid communication via the second vent path with a cover volume 676-2 defined between the outer surface of the PCBA and a cavity 674-2 disposed in the cover.

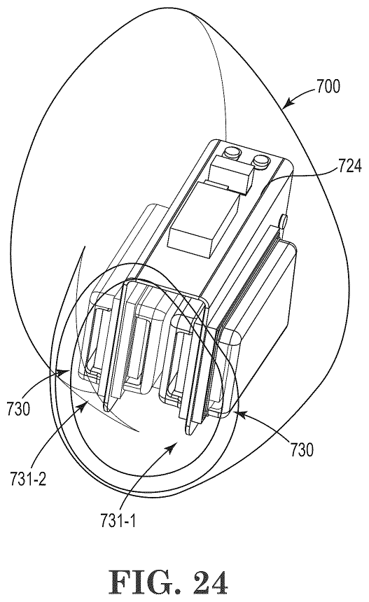

As mentioned herein, the various embodiments of ear-wearable electronic devices described herein can include any suitable number of MEMS receivers. For example, FIG. 24 is a schematic perspective view of another embodiment of an ear-wearable electronic device 700. All design considerations and possibilities described herein regarding ear-wearable electronic device 400 of FIGS. 4-17 and ear-wearable electronic device 600 of FIGS. 21-23 apply equally to ear-wearable electronic device 700 of FIG. 24. As shown in FIG. 24, the device 700 includes a first pair 731-1 of MEMS receivers 730 and a second pair 731-2 of MEMS receivers, where the receivers of each pair are coupled so that a rear volume of one receiver of the pair is coupled to the rear volume of the other receiver of the same pair via of vents (not shown) of the receivers that are fluidly connected by a vent path that extends through PCBA 724. In one or more embodiments, the first pair 731-1 of MEMS receivers 730 is coupled independently from the second pair 731-2 of MEMS receivers.

The various embodiments of ear-wearable electronic devices described herein can include any suitable electronic components or circuitry. For example, FIG. 14 is a block diagram that illustrates the ear-wearable electronic device 400 including electromechanical package 422 of FIGS. 4-13 and 15-17. The device 400 includes the enclosure 418. The device 400 shown in FIG. 14 can represent a single device configured for monaural or single-ear operation or one of a pair of hearing devices configured for binaural or dual-ear operation. Various components are situated or supported within or on the enclosure 418.

The device 400 includes a processor 481 operatively coupled to a main memory 482 and a non-volatile memory 483. The processor 481 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 481 can include or be operatively coupled to main memory 482, such as RAM (e.g., DRAM, SRAM). The processor 481 can include or be operatively coupled to non-volatile (persistent) memory 483, such as ROM, EPROM, EEPROM or flash memory.

The device 400 also includes an audio processing facility operably coupled to, or incorporating, the processor 481. The audio processing facility includes audio signal processing circuitry (e.g., analog front-end, analog-to-digital converter, digital-to-analog converter, DSP, and various analog and digital filters), a microphone arrangement 480, and the MEMS receiver 430. Each of the microphone arrangement 480 and MEMS receiver 430 can be disposed on or at least partially within the PCBA 424 disposed within the enclosure 418.

The microphone arrangement 480 can include one or more discrete microphones or a microphone array(s) (e.g., configured for microphone array beamforming). Each of the microphones of the microphone arrangement 480 can be situated at different locations within the enclosure 418. It is understood that the term microphone used herein can refer to a single microphone or multiple microphones unless specified otherwise. The microphone 480 is operatively coupled to the processor 481 and is configured to direct a microphone signal to the processor, which in turn directs a receiver signal to the MEMS receiver 430 that is based at least in part on the microphone signal.

At least one of the microphones 480 may be configured as a reference microphone that produces a reference signal in response to external sound outside the ear canal 460 of the wearer. Generally, at least one of the reference microphones 480 (also referred to as an externally facing microphone) is acoustically coupled to ambient air outside the enclosure 418 via an acoustic pathway or acoustic port 489 and a microphone inlet 488. The microphone inlet 488 allows air to pass between two parts of the enclosure 418 or may be formed within one part of the enclosure. In one or more embodiments, the microphone inlet 488 is disposed in the faceplate 416 of the device 400.

The device 400 can also include a user control interface 484 operatively coupled to the processor 481. The user control interface 484 is configured to receive an input from the wearer of the device 400. The input from the wearer can be any type of user input, such as a touch input, a gesture input, or a voice input. The user control interface 484 may be configured to receive an input from the wearer of the device 400.

The device 400 can include one or more communication devices 485. For example, the one or more communication devices 485 can include one or more radios coupled to one or more antenna arrangements that conform to an IEEE 802.13 (e.g., Wi-Fi®) or Bluetooth® (e.g., BLE, Bluetooth® 4.2, 5.0, 5.1, 5.2 or later) specification, for example. In addition, or alternatively, the device 400 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 485 can also include wired communications, e.g., universal serial bus (USB) and the like. Further, the communication devices 485 can include a flexible antenna disposed on or at least partially within the PCBA 424 disposed within the enclosure 418.

The device 400 also includes a power source 487, which can be a conventional battery, a rechargeable battery (e.g., a lithium-ion battery), or a power source including a supercapacitor. In the embodiment shown in FIG. 14, the device 400 includes a rechargeable power source 487 that is operably coupled to power management circuitry for supplying power to various components of the device 400. The rechargeable power source 487 is coupled to charging circuity 486. The charging circuitry 486 is, for example, electrically coupled to charging contacts on the enclosure 418 that are configured to electrically couple to corresponding charging contacts of a charging unit when the device 400 is placed in the charging unit.

The device 400 can further include any other suitable electronic elements or components. Although not shown, the device 400 can include one or more inertial measurement units (IMUs) disposed within the enclosure 418. In one or more embodiments, such IMUs can be disposed on or at least partially within PCBA 424 that is disposed within the enclosure 418.

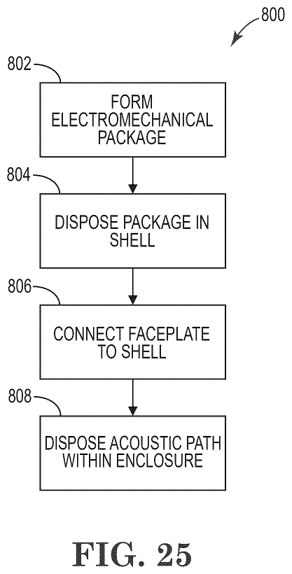

The various embodiments of ear-wearable electronic devices described herein can be manufactured using any suitable technique. For example, FIG. 25 is a flowchart of one embodiment of a method 800 for forming the ear-wearable electronic device 400 of FIGS. 4-17. Although described regarding ear-wearable electronic device 400, the method 800 can be utilized to form any suitable ear-wearable electronic device.

At 802, the electromechanical package 422 can be formed or manufactured utilizing any suitable technique. For example, the PCBA 424 can be formed into a nonplanar shape that includes the concave inner surface 426 and the concave outer surface 428. In one or more embodiments, the electromechanical package 422 can further be formed by disposing the vent path 466 through the PCBA 424 so that the vent 464 of the MEMS receiver 430 is in fluid communication with the vent path via the first opening 468 of the vent path. Further, in one or more embodiments, the cover 472 can be disposed on the outer surface 428 of the PCBA 424 and over the second opening 470 of the vent path 466 using any suitable technique, where the vent 464 of the MEMS receiver 430 is in fluid communication via the vent path with the cover volume 476 defined between the outer surface of the PCBA and the cavity 474 disposed in the cover. In one or more embodiments, the electromechanical package 422 can further be formed by disposing a second MEMS receiver (e.g., second MEMS receiver 630-2 of FIG. 21) on or at least partially in the inner surface 426 of the PCBA 424 using any suitable technique. In embodiments where the device 400 includes the second MEMS receiver, the electromechanical package 422 can further be formed by disposing the second vent path through the PCBA, where the vent of the second MEMS receiver is in fluid communication via the second path with the cover volume between the outer surface 428 of the PCBA and the cavity disposed in the second cover.

Further, the MEMS receiver 430 can be disposed on or at least partially in the concave inner surface 426 of the PCBA 424 using any suitable technique. In one or more embodiments, the MEMS receiver 430 can be disposed on or at least partially in the concave inner surface 426 of the PCBA 424 by disposing the MEMS receiver at least partially within the interior space 450 defined by the inner surface of the PCBA. The MEMS receiver 430 can be disposed on any suitable portion of the PCBA 424, e.g., on one or more of the rigid portions 458 of the PCBA.

At 804, the electromechanical package 422 can be disposed at least partially within the shell 402 using any suitable technique. In one or more embodiments, the electromechanical package 422 is disposed proximate to the first end 408 of the shell 402. The faceplate 416 can be connected to the second end 410 of the shell 402 at 806 using any suitable technique to form the enclosure 418 with the shell, where the enclosure includes the inner volume 420. Further, at 808, the acoustic path 432 can be disposed at least partially within the enclosure 418, where the acoustic path extends between the inlet 434 that is acoustically coupled to the receiver port 436 of the MEMS receiver 430 and the outlet 438 that is disposed at the first end 408 of the shell 402. Any suitable technique can be utilized to dispose the acoustic path 432 at least partially within the enclosure 418.

Embodiments of the disclosure are defined in the claims; however, herein there is provided a non-exhaustive listing of non-limiting examples. Any one or more of the features of these examples can be combined with any one or more features of another example, embodiment, or aspect described herein.

Example Ex1. An ear-wearable electronic device that includes a shell including an outer surface that corresponds to an ear geometry of an ear of a wearer of the device, a first end configured to be disposed in an ear canal of the ear of the wearer, and a second end configured to be disposed proximate to a concha of the ear of the wearer. The device further includes a faceplate connected to the second end of the shell to form an enclosure with the shell that has an inner volume, and an electromechanical package disposed at least partially within the enclosure. The package includes a flexible printed circuit board assembly (PCBA) disposed within the enclosure proximate to the first end of the shell and extending along an assembly axis, where the PCBA includes a concave inner surface and a convex outer surface; and a micro-mechanical systems (MEMS) receiver disposed on or at least partially in the concave inner surface of the PCBA. The device further includes an acoustic path disposed at least partially within the enclosure and extending between an inlet that is acoustically coupled to a receiver port of the MEMS receiver and an outlet that is disposed at the first end of the shell.

Example Ex2. The device of Ex1, where the PCBA includes a U shape in a cross-sectional plane orthogonal to the assembly axis.

Example Ex3. The device of Ex1, where the PCBA includes a rectangular shape in a cross-sectional plane orthogonal to the assembly axis.

Example Ex4. The device of any one of Ex1-Ex3, where the assembly axis is substantially orthogonal to a plane defined by the outlet of the acoustic path.

Example Ex5. The device of any one of Ex1-Ex4, where the assembly axis is substantially parallel to an ear canal axis of an ear of a wearer.

Example Ex6. The device of any one of Ex1-Ex5, where the inner surface of the PCBA defines an interior space, where the MEMS receiver is at least partially disposed within the interior space.

Example Ex7. The device of any one of Ex1-Ex6, where the PCBA includes a rigid portion and a flexible portion, where the MEMS receiver is disposed on or at least partially in the rigid portion.

Example Ex8. The device of any one of Ex1-Ex7, where the MEMS receiver includes a vent in fluid communication with a vent path that extends through the PCBA between a first opening defined by the inner surface of the PCBA and a second opening defined by the outer surface of the PCBA, where the vent is in fluid communication with the inner volume of the enclosure via the vent path, where the electromechanical package further includes a cover disposed on the outer surface of the PCBA and over the second opening of the vent path, and where the vent is in fluid communication via the vent path with a cover volume defined between the outer surface of the PCBA and a cavity disposed in the cover.

Example Ex9. The device of any one of Ex1-Ex8, further including a second MEMS receiver disposed on or at least partially in the inner surface of the PCBA.

Example Ex10. The device of Ex9, where the second MEMS receiver includes a vent in fluid communication with a second vent path that extends through the PCBA between a first opening defined by the inner surface of the PCBA and a second opening defined by the outer surface of the PCBA, where the vent of the second MEMS receiver is in fluid communication with the inner volume of the enclosure via the second vent path, where the device further comprises a second cover disposed on the outer surface of the PCBA and over the second vent opening of the second vent path, and where the vent of the second MEMS receiver is in fluid communication via the second vent path with a cover volume defined between the outer surface of the PCBA and a cavity disposed in the second cover.

Example Ex11. An electromechanical package for an ear-wearable electronic device. The package includes a flexible printed circuit board assembly (PCBA) extending along an assembly axis, where the assembly includes a concave inner surface and a convex outer surface. The package further includes a micro-mechanical systems (MEMS) receiver disposed on or at least partially in the concave inner surface of the PCBA so that the MEMS receiver is disposed within an interior space defined by the concave inner surface of the PCBA, where the MEMS receiver includes a receiver port.

Example Ex12. The package of Ex11, where the PCBA includes a U shape in a cross-sectional plane orthogonal to the assembly axis.

Example Ex13. The package of Ex11, where the PCBA includes a rectangular shape in a cross-sectional plane orthogonal to the assembly axis.

Example Ex14. The package of any one of Ex11-Ex13, where a normal to a plane defined by the receiver port is substantially parallel to the assembly axis.

Example Ex15. The package of any one of Ex11-Ex14, where the inner surface of the PCBA defines an interior space, where the MEMS receiver is at least partially disposed within the interior space.

Example Ex16. The package of any one of Ex11-Ex15, where the PCBA further includes a rigid portion and a flexible portion, where the MEMS receiver is disposed on or at least partially in the rigid portion.

Example Ex17. The package of any one of Ex11-Ex16, where the MEMS receiver further includes a vent in fluid communication with a vent path that extends through the PCBA between a first opening defined by the inner surface of the PCBA and a second opening defined by the outer surface of the PCBA, where the package further includes a cover disposed on the outer surface of the PCBA and over the second opening of the vent path, and where the vent is in fluid communication via the vent path with a cover volume defined between the outer surface of the PCBA and a cavity disposed in the cover.

Example Ex18. The package of any one of Ex11-Ex17, further including a second MEMS receiver disposed on or at least partially in the inner surface of the PCBA, where the second MEMS receiver includes a vent in fluid communication with a second vent path that extends through the PCBA between a first opening defined by the inner surface of the PCBA and a second opening defined by the outer surface of the PCBA, where the package further includes a second cover disposed on the outer surface of the PCBA and over the second vent opening of the second vent path, where the vent is in fluid communication via the second vent path with a cover volume defined between the outer surface of the PCBA and a cavity disposed in the second cover.

Example Ex19. A method of forming an ear-wearable electronic device, including forming an electromechanical package. Forming the package includes forming a flexible printed circuit board assembly (PCBA) into a non-planar shape that includes a concave inner surface and a convex outer surface, and disposing a micro-mechanical system (MEMS) receiver on or at least partially in the concave inner surface of the PCBA. The method further includes disposing the electromechanical package at least partially within a shell, where the shell includes an outer surface that corresponds to an ear geometry of an ear of a wearer of the device, a first end configured to be disposed in an ear canal of the ear of the wearer, and a second end configured to be disposed proximate to a concha of the ear of the wearer; connecting a faceplate to the second end of the shell to form an enclosure with the shell that has an inner volume; and disposing an acoustic path at least partially within the enclosure, where the acoustic path extends between an inlet that is acoustically coupled to a receiver port of the receiver and an outlet that is disposed at the first end of the shell.

Example Ex20. The method of Ex19, where disposing the MEMS receiver includes disposing the MEMS receiver at least partially within an interior space defined by the inner surface of the PCBA.

Example Ex21. The method of any one of Ex19-Ex20, where disposing the MEMS receiver includes disposing the MEMS receiver on a rigid portion of the PCBA.

Example Ex22. The method of any one of Ex19-Ex21, where forming the electromechanical package further disposing a vent path through the PCBA, where the vent path includes a first opening defined by the inner surface of the PCBA and a second opening defined by the outer surface of the PCBA, where a vent of the MEMS receiver is in fluid communication with the vent path via the first opening; and disposing a cover on the outer surface of the PCBA and over the second opening of the vent path, where the vent of the MEMS receiver is in fluid communication via the vent path with a cover volume defined between the outer surface of the PCBA and a cavity disposed in the cover.

Example Ex23. The method of Ex22, where forming the electromechanical package further includes disposing a second MEMS receiver on or at least partially in the inner surface of the PCBA.

Example Ex24. The method of Ex23, where forming the electromechanical package further includes disposing a second vent path through the PCBA, where the second vent path includes a first opening defined by the inner surface of the PCBA and a second opening defined by the outer surface of the PCBA, where a vent of the second MEMS receiver is in fluid communication with the second vent path via the first opening; and disposing a second cover on the outer surface of the PCBA and over the second opening of the second vent path, where the vent of the second MEMS receiver is in fluid communication via the second vent path with a cover volume defined between the outer surface of the PCBA and a cavity disposed in the second cover.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. An ear-wearable electronic device, comprising:
a shell comprising an outer surface that corresponds to an ear geometry of an ear of a wearer of the device, a first end configured to be disposed in an ear canal of the ear of the wearer, and a second end configured to be disposed proximate to a concha of the ear of the wearer;
a faceplate connected to the second end of the shell to form an enclosure with the shell comprising an inner volume;
an electromechanical package disposed at least partially within the enclosure, the package comprising:
a flexible printed circuit board assembly (PCBA) disposed within the enclosure proximate to the first end of the shell and extending along an assembly axis, the PCBA comprising a concave inner surface and a convex outer surface; and
a micro-mechanical systems (MEMS) receiver disposed on or at least partially in the concave inner surface of the PCBA; and
an acoustic path disposed at least partially within the enclosure and extending between an inlet that is acoustically coupled to a receiver port of the MEMS receiver and an outlet that is disposed at the first end of the shell.

2. The device of claim 1, wherein the PCBA comprises a U shape or a rectangular shape in a cross-sectional plane orthogonal to the assembly axis.

3. The device of claim 1, wherein the assembly axis is substantially orthogonal to a plane defined by the outlet of the acoustic path.

4. The device of claim 1, wherein the inner surface of the PCBA defines an interior space, wherein the MEMS receiver is at least partially disposed within the interior space.

5. The device of claim 1, wherein the PCBA comprises a rigid portion and a flexible portion, wherein the MEMS receiver is disposed on or at least partially in the rigid portion.

6. The device of claim 1, wherein the MEMS receiver comprises a vent in fluid communication with a vent path that extends through the PCBA between a first opening defined by the inner surface of the PCBA and a second opening defined by the outer surface of the PCBA, wherein the vent is in fluid communication with the inner volume of the enclosure via the vent path, wherein the electromechanical package further comprises a cover disposed on the outer surface of the PCBA and over the second opening of the vent path, wherein the vent is in fluid communication via the vent path with a cover volume defined between the outer surface of the PCBA and a cavity disposed in the cover.

7. The device of claim 1, further comprising a second MEMS receiver disposed on or at least partially in the inner surface of the PCBA.

8. The device of claim 7, wherein the second MEMS receiver comprises a vent in fluid communication with a second vent path that extends through the PCBA between a first opening defined by the inner surface of the PCBA and a second opening defined by the outer surface of the PCBA, wherein the vent of the second MEMS receiver is in fluid communication with the inner volume of the enclosure via the second vent path, wherein the device further comprises a second cover disposed on the outer surface of the PCBA and over the second vent opening of the second vent path, wherein the vent of the second MEMS receiver is in fluid communication via the second vent path with a cover volume defined between the outer surface of the PCBA and a cavity disposed in the second cover.

9. An electromechanical package for an ear-wearable electronic device, the package comprising:
a flexible printed circuit board assembly (PCBA) extending along an assembly axis, the assembly comprising a concave inner surface and a convex outer surface; and
a micro-mechanical systems (MEMS) receiver disposed on or at least partially in the concave inner surface of the PCBA so that the MEMS receiver is disposed within an interior space defined by the concave inner surface of the PCBA, wherein the MEMS receiver comprises a receiver port.

10. The package of claim 9, wherein the PCBA comprises a U shape or a rectangular shape in a cross-sectional plane orthogonal to the assembly axis.

11. The package of claim 9, wherein a normal to a plane defined by the receiver port is substantially parallel to the assembly axis.

12. The package of claim 9, wherein the inner surface of the PCBA defines an interior space, wherein the MEMS receiver is at least partially disposed within the interior space.

13. The package of claim 9, wherein the PCBA further comprises a rigid portion and a flexible portion, wherein the MEMS receiver is disposed on or at least partially in the rigid portion.

14. The package of claim 9, wherein the MEMS receiver further comprises a vent in fluid communication with a vent path that extends through the PCBA between a first opening defined by the inner surface of the PCBA and a second opening defined by the outer surface of the PCBA, wherein the package further comprises a cover disposed on the outer surface of the PCBA and over the second opening of the vent path, wherein the vent is in fluid communication via the vent path with a cover volume defined between the outer surface of the PCBA and a cavity disposed in the cover.

15. The package of claim 9, further comprising a second MEMS receiver disposed on or at least partially in the inner surface of the PCBA, wherein the second MEMS receiver comprises a vent in fluid communication with a second vent path that extends through the PCBA between a first opening defined by the inner surface of the PCBA and a second opening defined by the outer surface of the PCBA, wherein the package further comprises a second cover disposed on the outer surface of the PCBA and over the second vent opening of the second vent path, wherein the vent is in fluid communication via the second vent path with a cover volume defined between the outer surface of the PCBA and a cavity disposed in the second cover.

16. A method of forming an ear-wearable electronic device, comprising:
forming an electromechanical package, wherein forming the package comprises:
forming a flexible printed circuit board assembly (PCBA) into a non-planar shape comprising a concave inner surface and a convex outer surface; and
disposing a micro-mechanical system (MEMS) receiver on or at least partially in the concave inner surface of the PCBA;
disposing the electromechanical package at least partially within a shell, wherein the shell comprises an outer surface that corresponds to an ear geometry of an ear of a wearer of the device, a first end configured to be disposed in an ear canal of the ear of the wearer, and a second end configured to be disposed proximate to a concha of the ear of the wearer;
connecting a faceplate to the second end of the shell to form an enclosure with the shell comprising an inner volume; and
disposing an acoustic path at least partially within the enclosure, wherein the acoustic path extends between an inlet that is acoustically coupled to a receiver port of the receiver and an outlet that is disposed at the first end of the shell.

17. The method of claim 16, wherein disposing the MEMS receiver comprises disposing the MEMS receiver at least partially within an interior space defined by the inner surface of the PCBA.

18. The method of claim 16, wherein forming the electromechanical package further comprises:
disposing a vent path through the PCBA, wherein the vent path comprises a first opening defined by the inner surface of the PCBA and a second opening defined by the outer surface of the PCBA, wherein a vent of the MEMS receiver is in fluid communication with the vent path via the first opening; and
disposing a cover on the outer surface of the PCBA and over the second opening of the vent path, wherein the vent of the MEMS receiver is in fluid communication via the vent path with a cover volume defined between the outer surface of the PCBA and a cavity disposed in the cover.

19. The method of claim 18, wherein forming the electromechanical package further comprises disposing a second MEMS receiver on or at least partially in the inner surface of the PCBA.

20. The method of claim 19, wherein forming the electromechanical package further comprises:
disposing a second vent path through the PCBA, wherein the second vent path comprises a first opening defined by the inner surface of the PCBA and a second opening defined by the outer surface of the PCBA, wherein a vent of the second MEMS receiver is in fluid communication with the second vent path via the first opening; and
disposing a second cover on the outer surface of the PCBA and over the second opening of the second vent path, wherein the vent of the second MEMS receiver is in fluid communication via the second vent path with a cover volume defined between the outer surface of the PCBA and a cavity disposed in the second cover.
